(19) United States
(12) Patent Application Publication
(10) Pub. No.: US 2013/0073369 A1
(43) Pub. Date: Mar. 21, 2013

(54) System and Method For Influencing Consumer Purchasing Of Consumer Packaged Goods

(71) Applicant: Paul G. Begum, Laguna Niguel, CA (US)

(72) Inventor: Paul G. Begum, Laguna Niguel, CA (US)

(73) Assignee: KLEVER MARKETING, INC., Laguna Niguel, CA (US)

(21) Appl. No.: 13/622,350

(22) Filed: Sep. 18, 2012

Related U.S. Application Data
(60) Provisional application No. 61/536,188, filed on Sep. 19, 2011.

(51) Int. Cl. G06Q 30/06; G06Q 30/02

(52) U.S. Cl. 705/14.27; 705/26.1; 705/26.8

(57) ABSTRACT

The present invention has been developed in response to problems and needs in the art that have not yet been fully resolved by currently available marketing systems and methods, particularly in the area of consumer packaged goods (CPG). Thus, these systems and methods are developed to connect the consumers, retailers, and CPG companies together to entice consumers to buy brands and products of the CPG company brands, while engendering brand loyalty.

### CROSS-REFERENCE TO RELATED APPLICATIONS

This application claims priority to U.S. Provisional Patent Application No. 61/536,188 filed Sep. 19, 2011 and titled “A SYSTEM AND METHOD FOR INFLUENCING CONSUMER PURCHASING OF CONSUMER PACKAGED GOODS.”

### BACKGROUND

Advertising is the process through which companies attempt to convince customers to purchase their products. Advertising takes many forms including radio advertisements, in-store audio advertisements, television advertisements, billboards, etc. The production and broadcasting of these advertisements has become more and more expensive. Companies wish to maximize the effect of their advertisements by determining the most effective message to promote. Numerous marketing textbooks and classes discuss this field.

Consumer packaged goods (CPG) companies are particularly interested in advertising. CPG companies can include any companies that manufacture, or in some instances distribute, CPG. CPGs can include products that are sold quickly and at relatively low cost. Examples include such goods such as soft drinks, toiletries, and grocery items. These goods are generally replaced or fully used up over a short period of days, weeks, or months, and within one year, as opposed to durable goods or major appliances, which are generally replaced over a period of years. CPGs may generally have a short shelf life, either as a result of high consumer demand or because the product deteriorates rapidly. Some CPGs, such as meat, fruits and vegetables, dairy products and baked goods, are highly perishable. Other goods such as alcohol, toiletries, pre-packaged foods, soft drinks and cleaning products have high turnover rates. Accordingly, CPG companies generally attempt to sell high volumes of their goods, which may have low contribution margins, over extensive distribution networks. Thus, if CPG companies can influence brand loyalty, they may secure continual profitability.

One of the major obstacles in creating effective advertising is determining a customer's response to a particular advertisement. Traditionally companies have used focus groups and surveys in order to obtain customer response information about their products and/or advertisements. This customer response information can then be used to adjust or manipulate their advertisements. Unfortunately, these techniques of generating customer response information have been found to be inadequate and often inaccurate. Therefore, there is a need for a new method of generating customer response information that is both efficient and reliable.

Another problem with maximizing the effectiveness of advertising is the need to identify the most appropriate target audience. Some products are purchased by a wide variety of customers such as toilet paper and toothpaste while others are purchased by only a particular group. A significant loss in advertising effectiveness results if a wide-use product is only advertised to a select group of customers. Therefore, there is a need in the industry for a process of identifying a target group for a particular product, which can then be used to maximize the efficiency of a particular advertisement directed at selling the product. Further, there is a need to specifically tailor the content and durations of advertisements to reflect the shopping behaviors of each customer individually.

Another problem with maximizing the effectiveness of advertising is the need to cultivate brand loyalty that extends beyond sale periods to times when products and services are offered at regular prices. Findings show that in some categories, such as groceries, only a small minority of consumers are steadfast in their loyalty to a brand, while the majority of customers can be enticed and influenced to buy another brand's products. With these types of goods and services, promotions may not produce long term loyalty. Accordingly, there is a need to generate durable brand loyalty for those product lines in which customers can be readily enticed to purchase other bands.

To create brand loyalty a CPG company often focuses on three general categories: attraction, retention, and influence. For example, a CPG company can work to attract consumers and create brand awareness (such as enticing a consumer to make a first purchase of a particular brand). Such efforts can involve marketing campaigns, such as paper advertisements, television commercials, internet ads, internet pop-ups or banners, paper ads, etc.

Once a consumer is attracted to a particular brand, a CPG company attempts to retain consumers. In some instances, CPG companies emphasize the production of quality products that satisfy the consumer's desires in an effort to retain the consumer's loyalty. Other activities can be done by a CPG company to retain consumer loyalty, such as price differentiation, perpetual or long-term promotions or incentives, distinguishing features (e.g. more healthy products or additional health-related or environmentally-related components) as well as distinguishing product design or product packaging designs.

Finally, a CPG company attempts to influence customers. Brand influence may transcend attraction and retention and urge consumers to purchase the CPG company's products for the sake of the brand. CPG companies can perform various activities and provide various services, products, and product features to create influence.

### BRIEF SUMMARY

The present invention has been developed in response to problems and needs in the art that have not yet been fully resolved by currently available marketing systems and methods, particularly in the area of consumer packaged goods (CPG). Thus, these systems and methods are developed to connect the consumers, retailers, and CPG companies together to entice consumers to buy brands and products of the CPG company brands, while engendering brand loyalty.

In one embodiment, a method for influencing consumers to purchase products of a particular brand using a redemption bank includes implementing a redemption bank. The redemption bank comprises an account for one or more consumers into which a deposit can be made that can be used by the consumer as a credit towards the purchase of one or more products of a particular brand. A deposit is then made into an account of a first consumer. The deposit can be used by the consumer as a credit towards the purchase of one or more products of a brand of a first consumer packaged goods (CPG) company. A request of the first consumer is received to purchase one or more products of a brand of the first CPG company. The credit is then applied towards the purchase of the one or more products of the brand of the first CPG company.

This summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Additional features and advantages of the invention will be set forth in the description which follows, and in part will be obvious from the description, or may be learned by the practice of the invention. The features and advantages of the invention may be realized and obtained by means of the instruments and combinations particularly pointed out in the appended claims. These and other features of the present invention will become more fully apparent from the following description and appended claims, or may be learned by the practice of the invention as set forth hereinafter.

### BRIEF DESCRIPTION OF THE DRAWINGS

In order to describe the manner in which the above-recited and other advantages and features of the invention can be obtained, a more particular description of the invention briefly described above will be rendered by reference to specific embodiments thereof which are illustrated in the appended drawings. Understanding that these drawings depict only typical embodiments of the invention and are not therefore to be considered to be limiting of its scope, the invention will be described and explained with additional specificity and detail through the use of the accompanying drawings in which:

FIG. 1 illustrates an exemplary computer system in which the present invention can be implemented; and

FIG. 2 illustrates a flowchart of an exemplary method for influencing consumers to purchase products of a particular brand using a redemption bank.

### DETAILED DESCRIPTION

The present invention has been developed in response to problems and needs in the art that have not yet been fully resolved by currently available marketing systems and methods, particularly in the area of consumer packaged goods (CPG). Thus, these systems and methods are developed to connect the consumers, retailers, and CPG companies together to entice consumers to buy brands and products of the CPG company brands, while engendering brand loyalty.

In one embodiment, a method for influencing consumers to purchase products of a particular brand using a redemption bank includes implementing a redemption bank. The redemption bank comprises an account for one or more consumers into which a deposit can be made that can be used by the consumer as a credit towards the purchase of one or more products of a particular brand. A deposit is then made into an account of a first consumer. The deposit can be used by the consumer as a credit towards the purchase of one or more products of a brand of a first consumer packaged goods (CPG) company. A request of the first consumer is received to purchase one or more products of a brand of the first CPG company. The credit is then applied towards the purchase of the one or more products of the brand of the first CPG company.

Embodiments of the present invention may comprise or utilize special purpose or general-purpose computers including computer hardware, such as, for example, one or more processors and system memory, as discussed in greater detail below. Embodiments within the scope of the present invention also include physical and other computer-readable media for carrying or storing computer-executable instructions and/or data structures. Such computer-readable media can be any available media that can be accessed by a general purpose or special purpose computer system.

Computer-readable media is categorized into two disjoint categories: computer storage media and transmission media. Computer storage media (devices) include RAM, ROM, EEPROM, CD-ROM, solid state drives (“SSDs”) (e.g., based on RAM), Flash memory, phase-change memory (“PCM”), other types of memory, other optical disk storage, magnetic disk storage or other magnetic storage devices, or any other similarly storage medium which can be used to store desired program code means in the form of computer-executable instructions or data structures and which can be accessed by a general purpose or special purpose computer. Transmission media include signals and carrier waves.

Computer-executable instructions comprise, for example, instructions and data which, when executed by a processor, cause a general purpose computer, special purpose computer, or special purpose processing device to perform a certain function or group of functions. The computer executable instructions may be, for example, binaries, intermediate format instructions such as assembly language or P-Code, or even source code.

Those skilled in the art will appreciate that the invention may be practiced in network computing environments with many types of computer system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, tablets, pagers, routers, switches, and the like.

The invention may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices. An example of a distributed system environment is a cloud of networked servers or server resources. Accordingly, the present invention can be hosted in a cloud environment.

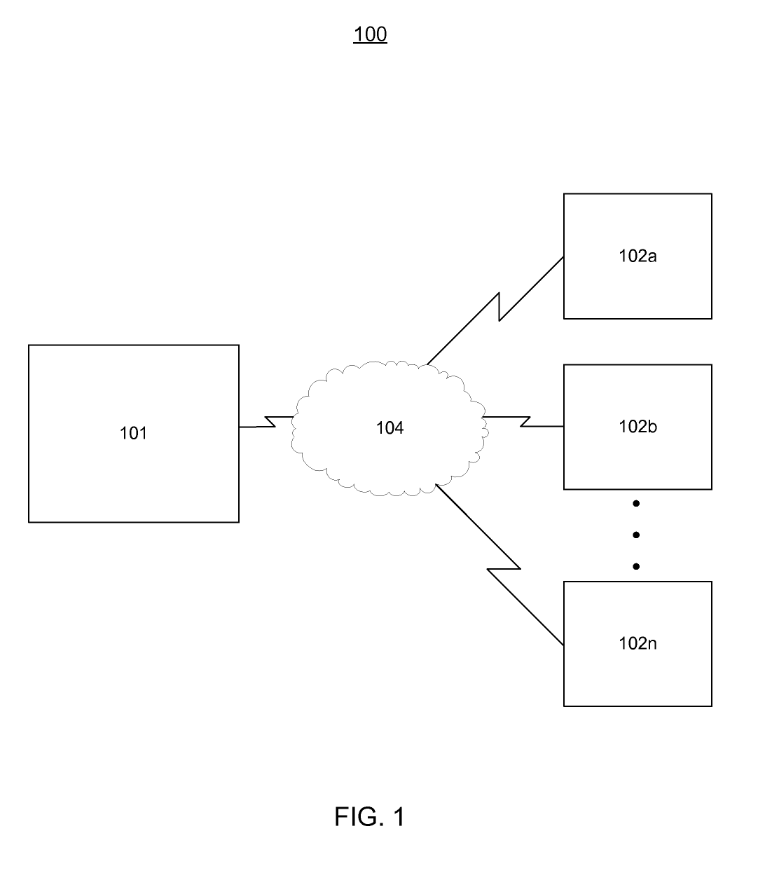

FIG. 1 illustrates an exemplary computer environment 100 in which the present invention can be implemented. Computer environment 100 includes server system 101 and client computer systems 102a-102n. Server system 101 communicates with client computer systems 102a-102n via network 104. Network 104 generally represents any means of communicating between two computer systems. Although not specifically illustrated, any of client computer systems 102a-102n can be configured to communicate directly (i.e. not over network 104) with any other client computer system 102a-102n.

Server system 101 can represent the computing components that are used to implement a redemption bank as described below. The computing components can comprise a single server or a group of interconnected servers or computer components.

Client computer systems 102a-102n represent each of the many different types of computing devices that can interface with the redemption bank hosted by server system 101. Client computer systems 102a-102n can include a retailer's computer system (e.g. local and remote servers, POS systems, etc.), a CPG company's computer system, a consumer's computer system (e.g. desktop, laptop, mobile phone, tablet, etc.), among others.

A redemption bank can be implemented to facilitate the process of creating brand loyalty. For example, a redemption bank can be maintained to allow a CPG company to make a deposit in the form of cash, coupons, credits, or the like. The deposit may include or may provide for a redemptive discount or credit toward the purchase of a product of one or more of the CPG's brands.

In some instances, the CPG deposit is applied to a consumer coupon or discount. Such deposits can be for generic redemptions, such as generic coupons to be used on any product of a certain brand. The deposit can be used for specific product redemptions, such as for specific products, specific product groupings or product lines, or specific brands of the CPG business. With specific product redemptions, the value of the deposit can be relative to the value of the specific good such as a percentage of the purchase price of the good or a specified dollar amount.

The redemption bank may be controlled by an intermediate organization, a system controller, which coordinates with the CPG, with retailers, and with the consumers, to facilitate the system. The system controller can, in some embodiments, include a computer system that performs some or all of the duties of the controller. The redemption bank can include a set of accounts, one or more for each CPG company or retailer. In some embodiments, the controller may provide one or more websites or other computer network location or site (herein website) which provides one or more user interfaces for CPG company personnel, retailer personnel, consumers, and others, to create and access an account through which it interacts with the controller. In some embodiments, only some interaction with the controller are done via the website. In other embodiments, nearly all or all of the interaction with the controller are done via the website.

The controller and/or the redemption bank can be a service offered to CPG companies and retailers that makes the connection to the consumers and distributes the redemption credit deposits to the consumers. The controller's connection to the consumers may entail a consumer subscribing to the services of the redemption bank, which may be administered via the website. Such a subscription may be free or require a one-time or periodic subscription fee. A user may subscribe to the website' s services via the website or via a paper application, such as one received via the mail, newspaper, or at a retail store.

Once a consumer has subscribed to the controller's services, the controller can provide the consumer with a variety of services, benefits, and tools. These tools can be shopping oriented and be directed to providing discounts to the consumer for products and brands provided by the CPG companies that make deposits into the redemption bank.

Generally, in some configurations, a user can submit a shopping list or otherwise request credits from the redemption bank for products of brands of one or more specific CPG company. These credits may be provided to the consumer for subscribing to the controller's services and/or provided to the consumer based on the consumer's prior purchases of a CPG company's products. These credits may be allocated to a consumer account associated with the consumer from which the consumer may withdraw the credits for use in purchasing goods from the depositing CPG company. For example, in some instances, a consumer accumulates points, discounts, or other such credits from a specific CPG company by making purchases of the CPG company's brands. In other instances, the consumer accumulates points discounts, or other such credits from the redemption bank by making purchases of any of the CPG companies who deposit into the redemption bank.

In some implementations, a user's purchasing activities can be tracked via a consumer card, a loyalty card, a credit card, an identification number or name, an account number, or the like. More specifically, a coupon card can be provided to the subscribing consumer onto which credits can be applied by the controller and/or website. In another embodiment, the consumer manages his/her account via a mobile application on a mobile device, which communicates with the website or the controller to track and manage the consumer's account. In some instances, credits can be applied or redeemed via the coupon card or a mobile application on a mobile device by presenting such to a check-out attendant in a store. Accordingly, in some instances, the controller provides subscribing consumers with a card, number, or the like. In some embodiments, the controller provides consumers with a credit card, which is provided at least in part via the controller.

When subscribing or signing up for an account, a consumer may provide personal information and other data that can be used by the website and/or controller to provide services to the consumer. In some embodiments, a consumer may provide data which may be used as a basis for correlating loyalty data tracking, which tracks the products and brands purchased by the consumer. In some embodiments, a customer may log onto the website and provide personal information comprising name, address, and/or certain shopping preferences. That personal data, in some embodiments, is correlated with a particular shopper and when that shopper enters the shopping environment, the purchase information acquired when the consumer purchases products is correlated with the shopper's personal data. In some embodiments, the identification of the stores that the consumer frequents and/or the information about the consumer's purchase history can allow for consumer specific and geographic specific advertisements, coupons, or suggested shopping lists to be provided to the customer.

In some embodiments, a consumer may, prior to entering a shopping environment, prepare a shopping list of goods the consumer intends or wishes to purchase. This shopping list feature can provide CPG companies and retailers with an early touch point with the consumer. In some embodiments, the shopping list is prepared via the website or mobile application, such as via an intelligent template that enables the consumer to submit a list of goods, meals, and/or recipes. When inserting a recipe, the website can automatically generate a list of goods the consumer needs to purchase in order to prepare the recipe. In some embodiments, the consumer prints the shopping list and brings it to the store, and during check-out the consumer or the check-out attendant can scan the shopping list to receive credits from the redemption bank.

As an addition or alternative to preparing a shopping list, the consumer can scan products he/she wishes to purchase using a mobile phone. In these embodiments, the consumer can download a mobile application to a mobile device, such as a smart phone. The mobile application can provide an interface through which a consumer can chose to scan a product and request a credit from the consumer's account to be applied to the purchase of this product or place the product on the consumer's shopping list. The mobile application can interact with the website and/or the controller to request and receive approval or denial of the consumer's request and/or place the product on the consumer's shopping list. In some embodiments, the application API will allow other mobile application developers to plug and act as an ATM for the bank or the redemption bank. This can allow scalable coverage to the consumer base.

Once the shopping list is prepared, either via a website, paper, or via a mobile application, the shopping list can be submitted. The shopping list can function as a withdrawal slip that is sent to the bank. In some instances, this shopping list is processed and converted into a withdrawal slip to the redemption bank. This conversion can be effected by the website, a mobile application, or another processing device. This withdrawal slip can provide information about the products the consumer wants to buy.

After a consumer submits a grocery list, and it is received as such or as a withdrawal slip, the system determines if credits can be given to the consumer for any of the items on the list. This determination will query whether or not the consumer has any credits in his/her account (by checking a consumer credit balance), what CPG companies make the brands of products on the list, and whether the CPG company who manufactures the listed products will provide credits for any of the items on the list. Consumers may earn or be rewarded credits based on their loyalty (e.g. in buying specific brands) and/or their frequency of using the bank.

In some embodiments, when a CPG company makes a deposit into the redemption bank, it identifies one or more products, such as a list of products, to which the credits can be applied. In some implementations, credits may be withdrawn in the form of a coupon, in which the value of the discount on the coupon is the value of the credit applied. When determining if a withdrawal of credits can be issued to a consumer based on a submitted shopping list or the scan of an item, the system may determine if any of the credits in the consumer's account can be applied to any of these items. In some instances, the system is configured to maximize the credits provided to the consumer for each submission by determining which of the various credit coupon combinations will provide the largest number of credits for the given shopping list.

Also, in some instances, if the system determines that no credits can be applied to any item or a shopping list, the system can be configured to offer recommendations for like items that do qualify for a credit. And in some instances, the system is configured to provide recommended products to the consumer which would qualify for a credit withdrawal. Such recommendations may related to items on the consumer's shopping list, recipes submitted by the consumer, items related to prior purchases by the user, or items preferred by the consumer as evidenced from past purchases.

When the particular customer uses a mobile device to submit a shopping list or a withdrawal slip, the system may identify the consumer's location and even the specific retail location of the consumer. In some embodiments, this location data may be factored in to the system's determination of recommended products and/or the credits which may apply to the consumer. For example, in some embodiments, a credit is deposited by a retailer or is retailer specific. Accordingly, the intended retailer may be submitted with the shopping list or it may be determined by a location device (e.g. a global positioning system (GPS)) of the consumer's mobile device. Accordingly one or more credits germane to that customer's preferences and to the geographic position of the retail store may be recommended or presented to the consumer.

In a non-limiting example, a customer who has input personal information into an account profile, such as on a website, and/or who has a prior history of purchasing a particular product may receive a coupon credit to purchase that product or a related product. Such a coupon credit may be available only at a particular store, which the system determines the consumer is visiting. Accordingly, in some embodiments, there is a substantial overlap between the user's account, the system, and use of the mobile device.

In some embodiments, the system tracks a user's shopping behavior, including, for example, the products and product brands the user purchases when using the consumer's account and/or the data created by tracking the shopper's consumer behaviors, and correlates this behavior with a specific customer. This correlation may be via an identification number, previously supplied personal information, a consumer card, or the like. The data collected about the consumer's shopping behavior can be used by the CPG company to identify the effectiveness of advertisements, marketing approaches, and specific credits, such as coupon credits provided via the system.

Accordingly, in some instances, the system delivers tailored messages and product offers from retailers and CPG companies to the consumer. These messages and offers may be delivered via the mail or email. In other instances, such communication is provided to the consumer at the point-of-purchase, such as on a message printed on the back of a receipt or as a separately printed message. In still other instances, this communication is sent to the user via a mobile device. Such messages and offers may be presented by the mobile application and may appear in an inbox, a message center, as pop-up notifications, notifications, or otherwise presented. In yet other instances, this communication is sent to the consumer via the website. The website may present various tools, tabs, screens, and services to the consumer. These messages and offers may be presented to the user via one such tool, tab, screen, or service, including a message service.

After the redemption bank approves of a withdrawal, the consumer is presented with the option of approving or rejecting each withdrawal. As with previously described processes, this process may be performed via the website, via a mobile application on a mobile phone, via mail or email, at a retail store, or at other such locations. In a representative example, the redemption bank may indicate to the consumer that a $0.75 off credit is available for a specific product. The consumer may then approve or reject this withdrawal. In another representative example, the redemption bank may provide the consumer with a list of multiple credits or credit scenarios available to the consumer. The consumer may then select from among the credits or credit scenarios. At this time the user may also approve of other recommended products or substitute alternative products suggested by the system.

In some configurations, the system can provide the consumer with an estimated total cost of the approved shopping list, including the applied credits. This estimate may be based on manufacturer suggested retail prices, or it may be based on actual in-store prices of a particular retailer. Thus, in some instances, the system receives or has access to in-store prices and/or in-store promotions from one or more specific retailers.

After a consumer approves a withdrawal, the redemption bank transfers credits to the user. The transfer can be to the issued consumer card, such as a coupon card. The transfer can also be a download to a mobile device. The consumer card or mobile device can then be used when the consumer purchases the intended products at a retail store. The details of the transfer may be hidden from the consumer. The transfer may involve the internal transfer of credits from an account in the redemption bank to a consumer's individual account.

After the redemption bank issues a withdrawal, the consumer can shop for and/or purchase groceries using the issued credits. In some instances, the system includes one or more associated retailers or chains of retail stores. In other instances, the system and the credits can be used at any retailer. The consumer may redeem the credits at check-out by swiping the consumer card, such as the coupon card, or presenting a mobile device, or by presenting a coupon or other printed material that indicates the consumer's credits.

In some embodiments, the mobile application on the consumer's mobile device provides additional services to the consumer. These services may include a scanner feature that permits a user to photograph or scan a product to identify the product. The scanning feature may be configured to read the barcode or other label of a product and identify the product, the product brand, and even the product price or manufacturer suggested retail price. By scanning products, a consumer can automatically track the items in his/her shopping cart and/or check items off the shopping list. If the mobile application has access to retail store prices, the consumer can also keep a running total of the cost of the items in his/her shopping cart. In some instances, the mobile application can access other such in-store services.

In some configurations, the system can incorporate a smart shopping cart. Smart shopping carts can include those disclosed in U.S. Pat. No. 6,323,753 and 6,177,880 and United States Patent Application No. 2001/0028301, which are herein incorporated by reference. Smart shopping carts can include one or more displays attached thereto, which present store and product related information to a user. The smart shopping cart can determine its location in the store and/or present the consumer with information about products in that location. In some embodiments, the smart shopping cart includes a card reader, a port, a communications device or other such device for reading the consumer's consumer card or communicating with the consumer's mobile device. As such, the smart shopping cart can receive the consumer's shopping list, direct the consumer around the store, notify the consumer of store-specific services or sales, or assist to calculate the running total of the cost of products in the cart. These and various other features and services can be performed by the smart shopping cart in combination with the present system.

After a consumer has purchased CPGs using the system, the system confirms the purchase. The system may be informed of the purchase via the point of sale device, the user's mobile device, or a report received from the retailer. Once the information relating to the purchase is received it can be reviewed. The review can verify that products previously approved of were actually purchased using the issued credit. If it is determined that the products purchased were in fact the pre-approved goods, then the redemption is validated. In some embodiments, the system reports this valid redemption to the CPG company whose product was purchased. The CPG company can then issue a refund to the retailer for the discounted price of the goods purchased by the consumer.

In some embodiments, the system can also receive data regarding other products purchased by the consumer while using the consumer card, mobile application, or other form of identification. Using the information relating to the consumer's purchases, the system can provide the consumer with additional credits in the redemption bank. These new credits can be based on the brands purchased by the consumer. For example, if the consumer made purchases of a certain number or a certain dollar amount of goods from Brand A, they can receive a deposit into his/her account. In this way, the CPG company that produced Brand A products can make a deposit into the consumer's account with the redemption bank to reward the consumer for loyalty to the brand. This system can influence the consumer's behavior to continue to purchase products of Brand A. In this manner, the system can function cyclically, wherein consumers are influenced to purchase products of a specific brand of a CPG company and that purchase influences the consumer to continue purchasing products of the same brand.

### Values and Benefits

This system can benefit consumers by empowering the consumer to make informed buying decisions. This empowerment can come from information presented to the consumer via the website, mobile application, other materials, or the smart shopping cart, described above. This system also allows consumers to save money on the products of their choice since they may continually save money on such products and the repeat purchase of such products. The system can also enable consumers to use their time more effectively, since it facilitates the preparation of shopping lists and other shopping planning that takes place between the preparation of a shopping list and check-out. In some embodiments, the system is connected to one or more social media networks, through which consumers, retailers, and CPG companies can communicate. This system can also enhance and utilize the functionality of smart shopping carts, as described above. Thus, consumers can receive numerous benefits using the system.

This system may also benefit associated retailers by making an impression on consumers that entices them to buy the products they need and want at the retailer's facility. Furthermore, in some embodiments, the retailer is provided access to analytics prepared and compiled by the system that assist the retailer to understand the consumer's needs. Embodiments of the system can also provide retailers with the ability to communicate tailored messages and offers to target consumers. For example, by knowing which products a consumer prefers and consistently buys, retailers can target specific target messages to the consumers. Such messages can be sent to consumers via the website, mobile application, other materials, or the smart shopping cart, or via another means. Retailers also assist in permitting customers to customize the shopping experience. The system can also provide retailers with the ability to direct cross and up selling, offer in-store, private brand promotions and manufacturer's specials to the consumer. These promotions and offers can be communicated to the consumer via the system. Furthermore, in some instances, the retailer may also make deposits into the redemption bank that can be used for credits to that particular retailer and thus influence the consumer to purchase groceries or other CPG items at that retailer.

This system may also benefit CPG companies by providing an effective way to target consumers who are interested in that CPG company's products. This can be more effective than ‘spray and pray’ redemption programs, such as coupons included in newspaper inserts. The system can also provide numerous touch-points at which the CPG company can influence the consumer, such as during the preparation of a shopping list or while looking at items on the store shelf. At these points, while shopping and products are directly on the minds of the consumer, the CPG can provide credits to the consumer to influence the consumer's purchasing choices. The system can increase redemption performance, since nearly all of the approved credits are more likely to be used by a consumer than with traditional advertisements or coupons. The system can also provide real-time or near-real time visibility and control of the redemption program budget and performance, since at each process (receipt of a shopping list/withdrawal slip, scanning, purchasing) the system can track consumer activity and thus redemption program performance. Embodiment of the system can also permit CPG companies to optimize the refund cycle, since each step may be tracked and analyzed.

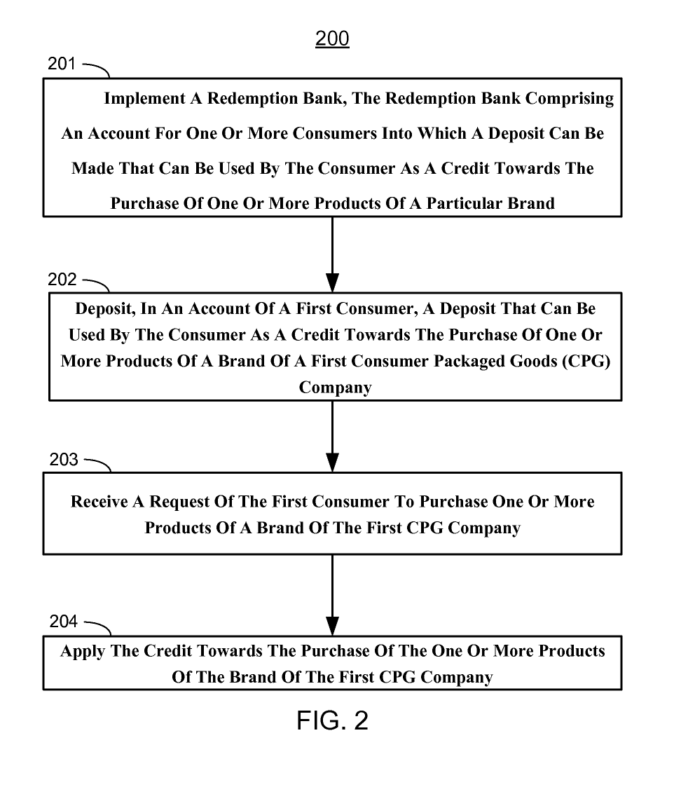

FIG. 2 illustrates a flowchart of an exemplary method 200 for influencing consumers to purchase products of a particular brand using a redemption bank. Method 200 will be described with reference to FIG. 1.

Method 200 includes an act 201 of implementing a redemption bank, the redemption bank comprising an account for one or more consumers into which a deposit can be made that can be used by the consumer as a credit towards the purchase of one or more products of a particular brand. For example, server system 101 can implement a redemption bank storing accounts for consumers using client computer system 102a-102n.

Method 200 includes an act 202 of depositing, in an account of a first consumer, a deposit that can be used by the consumer as a credit towards the purchase of one or more products of a brand of a first consumer packaged goods (CPG) company. For example, a deposit can be applied by server system 101 to an account of a consumer.

Method 200 includes an act 203 of receiving a request of the first consumer to purchase one or more products of a brand of the first CPG company. For example, a consumer using one or more of client computer systems 102a-102n can transmit a request to server system 101. The client computer system can be a consumer's personal computing device, a retail establishment's POS system, or any other computing device configured to communicate with server system 101.

Method 200 includes an act 204 of applying the credit towards the purchase of the one or more products of the brand of the first CPG company. For example, server system 101 can cause the purchase price of the one or more products to be reduced (e.g. by transmitting or applying a coupon or discount to the purchase, or otherwise crediting the first consumer for the use of the credit).

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed:

1. A method, performed by a server computing system, for influencing consumers to purchase products of a particular brand using a redemption bank, the method comprising:
implementing a redemption bank, the redemption bank comprising an account for one or more consumers into which a deposit can be made that can be used by the consumer as a credit towards the purchase of one or more products of a particular brand;
depositing, in an account of a first consumer, a deposit that can be used by the consumer as a credit towards the purchase of one or more products of a brand of a first consumer packaged goods (CPG) company;
receiving a request of the first consumer to purchase one or more products of a brand of the first CPG company; and
applying the credit towards the purchase of the one or more products of the brand of the first CPG company.

2. The method of claim 1, wherein the deposit is received from the first CPG company.

3. The method of claim 1, wherein the deposit specifies one or more brands of the first CPG company for which the credit is valid.

4. The method of claim 1, wherein the deposit is made in response to the first consumer purchasing one or more products of a brand of the first CPG company.

5. The method of claim 1, further comprising:
in response to the purchase of the one or more products, depositing a second deposit in the account of the first consumer that can be used by the first consumer as a credit towards the purchase of one or more products of a brand of the first CPG company.

6. The method of claim 1, further comprising:
receiving a shopping list of the first consumer, the shopping list specifying one or more products;
determining that a credit in the account of the first consumer can be used towards the purchase of at least one of the one or more products in the shopping list; and
sending a notification to the first consumer of the credit.

7. The method of claim 6, wherein the notification comprises an indication of a brand of the at least one product to which the credit applies.

8. The method of claim 6, wherein the notification comprises a recommended product to replace one or more products in the shopping list, the recommended product comprising a product to which at least one credit in the account of the first consumer applies.

9. The method of claim 1, wherein the credit is valid at a particular retail establishment.

10. The method of claim 1, further comprising:
identifying a recipe that the first consumer desires to prepare;
determining which products are required to prepare the recipe; and
sending, to the first consumer, an identification of each of the products that is required.

11. The method of claim 10 wherein the identification of at least one of the products identifies a credit that is available to be used towards the purchase of the product.

12. The method of claim 10, wherein the identification of each of the products comprises a shopping list.

13. The method of claim 1, wherein the credits comprise points redeemable for coupons or other discounts towards the purchase of products.

14. The method of claim 13, further comprising:
adding points to the account of the first consumer, the number of points being based on the number of products of a particular brand the consumer purchases.

15. The method of claim 14, further comprising;
receiving a shopping list of the first consumer, the shopping list specifying one or more products;
determining that no credits in the account of the first consumer can be used towards the purchase of the one or more products in the shopping list;
identifying an alternative product for at least one of the one or more products in the shopping list, wherein the account of the first consumer includes a credit that can be used towards the purchase of the alternative product; and
notifying the first consumer of the alternative product.

16. The method of claim 1, further comprising:
displaying a recipe to the first consumer;
receiving the selection of a first product in the recipe; and
adding the first product to a shopping list for the first consumer.

17. The method of claim 16, further comprising:
providing an indication of one or more credits in the account of the first consumer that are applicable to the first product.

18. The method of claim 17, further comprising:
receiving a request to purchase the first product; and
applying one or more credits towards the purchase of the first product.

19. The method of claim 18, further comprising:
making an additional deposit into the account of the first consumer in response to the first consumer purchasing the first product.

20. The method of claim 19, wherein the additional deposit comprises a credit towards the purchase of a product of the same brand as the first product.
